(19) United States
(12) Patent Application Publication
(10) Pub. No.: US 2005/0126692 A1
(43) Pub. Date: Jun. 16, 2005

(54) System and method for advancing thermoplastic adhesive segment dispensing tape and applying adhesive segments thereby

(76) Inventors: Roger V. Hajny, Cedarburg, WI (US); Burton J. Peterson, Waterford, WI (US); Dennis P. Tronca, Mequon, WI (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 11/007,844

(22) Filed: Dec. 9, 2004

Related U.S. Application Data
(60) Provisional application No. 60/528,243, filed on Dec. 9, 2003.

(51) Int. Cl. B32B 9/00; B32B 33/00; B44C 1/00; B32B 31/00

(52) U.S. Cl. 156/238; 428/40.7; 156/539

(57) ABSTRACT

An automated adhesive segment applicator apparatus is provided for use with an adhesive segment laden carrier release tape. The automated adhesive segment applicator has a carrier tape dispensing system including a supply spool upon which a roll of adhesive segment carrier release tape is mounted and a take-up spool configured to provide a carrier tape path whereby the adhesive segment-laden carrier release tape is prevented from becoming loose or pulling away from the adhesive segment applicator apparatus when an adhesive segment is dispensed, in order easily to dispense an adhesive segment to a surface. The automated adhesive segment applicator may be provided with at least one index marking detector for precise advancement of the carrier tape within the applicator.

This application claims the benefit of U.S. Provisional Patent Application No. 60/528,243, filed on Dec. 9, 2003, the entirety of which is incorporated herein by reference. This application is also related to concurrently filed copending U.S. patent application Ser. No. 10/944,535, filed on Sep. 17, 2004, entitled “System and Method for Advancing Thermoplastic Adhesive Segment Dispensing Tape and Applying Adhesive Segments Thereby,” which is hereby incorporated herein by reference.

### BACKGROUND OF THE INVENTION

Field of the Invention—The present invention relates generally to pressure-sensitive adhesives and their application to desired surfaces, and more specifically to an automated adhesive segment applicator used with rolls of indexed carrier release tape having pressure-sensitive adhesive segments disposed thereon which may be advanced and dispensed by the automated adhesive segment applicator of the present invention.

Adhesives are more than just substances serving to hold materials together by surface attachment. The term “adhesive” is simplistic and explains little, but generically describes a class of “sticky” materials. Adhesives and adhesive applicators owe their innovation to the Industrial Revolution, which resulted in an explosion of technical and scientific breakthroughs. The breakthroughs of the Industrial Revolution included the introduction of new materials and ingredients for use in formulating market-specific and industry-specific adhesives. In creating novel adhesives, companies have diligently considered desirable qualities such as adhesive flexibility, toughness, minimum curing or setting time, and temperature and chemical resistance. Today, the technology and underlying science of adhesives and apparatuses for their application is the foundation for a multi-billion dollar industry with over 700 companies competing for market share. More importantly, these companies strive to create and introduce novel adhesives as well as apparatuses and methods for the simple, efficient, inexpensive, and safe application of adhesives.

One of the most significant adhesive technical breakthroughs of the past century has been the introduction of pressure-sensitive thermoplastic adhesives. Thermoplastic adhesives have excellent adhering qualities; they can be softened by heating and firmed by cooling. These characteristics help thermoplastic adhesives produce waterproof, resilient, and long-lasting flexible bonds. Thermoplastic adhesives have what is known as a “plastic memory,” meaning that each time a thermoplastic adhesive is heated, it can be molded into any desired form.

Thermoplastic adhesives have significant applications in today's industry. For example, in the preparation of mass mailings, marketers often desire to attach a card, such as a credit card or the like, to a carrier document so that a consumer can peel the card easily from the carrier document. One method of making such an attachment involves the use of a pressure-sensitive, thermoplastic adhesive. For example, by using a heating container to melt thermoplastic adhesive and a metering pump to dispense it during the printing or collating process, a portion of thermoplastic adhesive can be metered onto the carrier document and the credit card pressed against it.

In addition to the uses for thermoplastic adhesives described above, industry is now finding additional uses for them. For example, thermoplastic adhesives are routinely used and applied as small bond points to eliminate the use of mechanical fasteners, such as staples, screws, rivets, clips, snaps, nails, and stitching. Thermoplastic adhesives are also extensively used in the packaging and manufacture of cartons, boxes and corrugated boards, bags, envelopes, disposable products (diapers and other paper products), cigarettes, labels, and stamps. In fact, today's demand for thermoplastic adhesives extends to very broad fields of use and is not limited to assembly line-like settings.

Increasingly, industry demands thermoplastic adhesive application at on-site locations from portable, simple-to-use, efficient, inexpensive, and safe dispensing apparatuses. Additionally, such dispensing apparatuses must be able to adhere thermoplastic adhesives to non-planar, recessed, difficult to reach, or unstable surfaces. Previously known apparatuses and methods have failed to provide an adequate portable, simple-to-use, efficient, inexpensive, and safe dispensing device and a thermoplastic adhesive carrying medium capable of applying thermoplastic adhesives to non-planar, recessed, difficult to reach, or unstable surfaces.

In providing thermoplastic adhesives for application to a surface, the previously known embodiments have contemplated all of the following thermoplastic adhesive carrying media and application methods: hot-melt “glue-gun” adhesive dispensers; adhesive segment-laden carrier release tape for “by hand” adhesive application; use of a plunger-like dispensing system in combination with adhesive segment-laden carrier release tape, which proves to be cumbersome and which has a limited utility of application to planar surfaces; use of a cardboard box applicator system for use in combination with adhesive segment-laden carrier release tape, which is also limited in application to planar, non-recessed surfaces; and an electric automated dispensing system for use with adhesive segment-laden carrier release tape, which is activated by the pressing of a palm-sized push button, and which also only allows for application of thermoplastic adhesives to unobstructed planar surfaces.

Using a “glue gun” device is an inefficient, difficult, and at times unsafe method of applying thermoplastic adhesives to a desired surface. First, the cost of using this equipment is relatively high. The apparatus and method are also inefficient consumers of both energy and glue. Specifically, the costs of the activation of such a dispenser (electrical usage, wasted glue from droppings) for only short periods of time outweigh any other potential advantages which may be realized.

Safety is also an issue. Glue-gun devices are potentially unsafe because they include a heat source to heat a quantifiable supply of adhesive material to its melting point. A major drawback of using such an instrument is that the hot, molten thermoplastic adhesive can burn untrained users, and can also melt the substrate the user is applying the glue to. Finally, application of thermoplastic adhesives from a glue-gun does not enable the thermoplastic adhesive to withstand cold temperatures or to cool to a smooth surface, but instead will typically leave “spider webs” in the dried adhesive. In short, glue-gun applicators of the prior art are inefficient, difficult, and unsafe.

Many of the shortcomings of the glue-gun instruments of the prior art were solved by U.S. Pat. No. 5,935,670 to Downs (the “'670 patent”), which patent is hereby incorporated herein by reference. However, upon further use of the technology of the '670 patent, several shortcomings have become apparent. Specifically, while the '670 patent discloses a method for presenting cooled adhesive segments for application to a desired surface, the application of the segments to the surface proves to be very inefficient.

The technology of the '670 patent focuses mainly on the manufacture of a clean, unaltered carrier release tape having first and second release surfaces with different coefficients of friction/release properties, and the application thereto of adhesive segments at periodic intervals. The adhesive segment-laden carrier release tape is then wound into a roll. This embodiment allows a user to apply the adhesive segments from the carrier release tape by hand. Although such an embodiment provides a highly innovative and commercially successful product, application of the adhesive segments remains inefficient and cumbersome.

Specifically, the coiled adhesive segment-laden carrier release tape must be unrolled to present an adhesive segment for application. After the adhesive segment has been applied to the desired surface, the tape must be unrolled an additional distance to ready the next adhesive segment for application. Such a method is time-consuming, and the “spent” carrier release tape must be either torn off and disposed of or left intact and in the way. Finally, dropping or uncoiling the unused roll of adhesive segment-laden carrier release tape has also been a problem.

U.S. Pat. No. 6,319,442 to Downs (the “'442 Patent”), which patent is hereby incorporated herein by reference, further evolved the previously known adhesive segment-laden carrier release tape of the '670 patent. Like the '670 patent, the '442 patent also contemplates a carrier release tape, which has first and second release surfaces with different coefficients of friction/release properties, and the application thereto of adhesive segments at periodic intervals. But unlike the '670 patent, the '442 patent contemplates a thermoplastic adhesive carrier release tape having a transverse line of slits or perforations precut across its transverse width and between the adhesive segments.

The precut tape of the '442 patent thus allows individual portions of the carrier release tape and associated thermoplastic adhesive to be removed from the roll for manual application to a desired surface. While such an embodiment remedies the '670 patent's problem of having a length of uncut spent carrier release tape, the carrier release tape of the '442 patent (as well as of the '670 patent) does not lend itself to use in combination with a more efficient dispenser for application of the adhesive segments to non-planar, recessed, difficult to reach, or unstable surfaces.

While the '670 and '442 patents focus primarily on the creation of adhesive segment-laden carrier release tape, they also contemplate use of the adhesive segment-laden carrier release tape in combination with numerous dispenser apparatuses. First, a plunger-like applicator, as detailed within both the '670 and '442 patents, proves manageable, but is limited in the type of surfaces that the thermoplastic adhesive may be applied to. Specifically, because the plunger mechanism has an attached planar foot portion, which is used to guide the placement of the adhesive segments, application of the thermoplastic adhesive segments is essentially confined to an unobstructed flat surface. Such a limitation can pose significant problems when attempting to apply thermoplastic adhesives to non-flat surfaces. It may be more practical to use the above “by hand” manual method of thermoplastic adhesive application.

Another previously known thermoplastic adhesive applicator that presents some apparent problems is the so-called box applicator. This applicator is also limited in thermoplastic adhesive application to planar surfaces. The box applicator encases a roll of adhesive segment-laden carrier release tape as disclosed within the '670 and '442 patents. When the carrier release tape is advanced from the box applicator by hand, the thermoplastic adhesive can only be applied to surfaces that are of a generally planar nature.

The adhesive segments must be pressed between the surface to be glued and the top of the cardboard box applicator to ensure adherence. This application process exposes unspent adhesive segments to dust and other debris, which may cause the adhesive segments to lose their adhesive tack and damage or soil the desired surface. Additionally, because the cardboard box thermoplastic adhesive applicator must be of a certain size to house a spool of carrier release tape, application of adhesive segments to areas that are non-flat or recessed proves to be difficult, if not impossible.

While not all previously known thermoplastic adhesive applicators are manual, even applicators that are automated present problems. For example, while automated thermoplastic adhesive applicators are more efficient than the box applicator described above, they are also more expensive. The previously known automated methods dispose of the need to manually advance the carrier release tape, but are one-of-a-kind units and thus represent a very expensive option for both the adhesive manufacturer and the end user. Automated thermoplastic adhesive applicators are also limited to thermoplastic adhesive application to generally planar surfaces. In short, their limitations are similar to those of the previously known embodiments presented above because, due to their size, they may not be positioned for the application of thermoplastic adhesive into recessed areas or onto generally non-flat surfaces.

In order to overcome the drawbacks of the aforementioned apparatuses and methods, a “gun-type” adhesive segment application apparatus capable of advancing and dispensing adhesive segments from an adhesive segment-laden carrier release tape was developed. (Examples of such “gun-type” adhesive segment application devices are disclosed in U.S. patent application Ser. No. 10/360,395 by Downs et al. filed Feb. 8, 2003, and U.S. patent application Ser. No. 10/368,231 by Downs et al. filed Feb. 18, 2003).

Such an adhesive segment application apparatus contains a drive mechanism for engaging an indexing instrumentality on the adhesive segment-laden carrier release tape to allow it to dispense adhesive segments, thereby solving the problems of prior art adhesive tape dispensing apparatuses. In addition, such an adhesive segment applicator apparatus is capable of applying adhesive segments to non-flat, recessed, difficult to reach, or unstable surfaces in a simple, efficient, safe, and automatic manner.

However, the aforementioned devices contain several drawbacks. First, the carrier tape tends to become loose and pulls away from the nose of the adhesive segment applicator apparatus or comes out of the applicator apparatus. When the carrier tape becomes loose, the adhesive segment is not easily applied to the intended surface. However, simply increasing the tension of the carrier tape impedes advancement of the carrier tape, and thus, causes problems in efficiency and automation of the application process.

In addition, the aforementioned adhesive segment applicator apparatus discharges spent carrier release tape which is cumbersome and awkward to deal with during a continuous operation. The spent carrier release tape can get in the way of processing and can require interference in application operations when disposal of the spent carrier release tape is necessary.

Accordingly, it is the primary objective of the present invention to provide an automated adhesive segment applicator apparatus capable of dispensing adhesive segments from an adhesive segment-laden carrier release tape in which an adhesive segment is easily applied to a surface without the release tape coming out of the applicator apparatus. It is therefore a related objective of the present invention that the adhesive segment applicator apparatus provide the adhesive segment-laden carrier release tape with sufficient tension to dispense an adhesive segment without the carrier release tape pulling away from the nose/application head of the adhesive segment applicator apparatus. It is a related objective of the present invention to provide the ability to easily and readily advance the adhesive segment-laden carrier release tape, exposing the next adhesive segment on the carrier release tape.

It is an additional objective of the present invention to provide an automated adhesive segment applicator apparatus in which the adhesive segment-laden carrier release tape advances to dispense an adhesive segment and which automatically winds spend tape onto a take-up core, thereby permitting adhesive segments to be dispensed while automatically advancing adhesive segment-laden carrier release tape to expose another adhesive segment to a surface. Thus, it is a related objective of the present invention to provide in a first embodiment an automatic advancing adhesive segment applicator apparatus that dispenses an adhesive segment and automatically and precisely advances the adhesive segment-laden carrier release tape to the next adhesive segment on the tape.

It is yet another object of the present invention to provide an adhesive segment applicator apparatus for use in industrial or high-throughput applications that includes a powered actuating mechanism for continuous and/or step-wise advancement of the adhesive segment-laden carrier release tape to expose an adhesive segment or a plurality of adhesive segments to a surface or work piece. It is another objective of the present invention that in other embodiments the adhesive segment applicator apparatus have an optical indexing sensor for detecting an indexing instrumentality on an adhesive segment-laden carrier release tape for precisely advancing the adhesive segment-laden carrier release tape.

It is a related objective of the present invention to provide an automated adhesive segment applicator apparatus configured with an applicator head capable of permitting application of an adhesive segment to a wide variety of work pieces and/or surfaces including nonplanar, nonrigid, recessed or unstable surfaces. [0028] Each implementation of the automated adhesive segment applicator apparatus of the present invention must also be of construction which is both durable and long lasting, and they should also require little or no maintenance to be provided by the user throughout its operating lifetime. In order to enhance the market appeal of the automated adhesive segment applicator apparatuses of the present invention, they should also be of inexpensive construction to thereby afford them the broadest possible market. Finally, all of the aforesaid advantages and objectives of the adhesive segment applicator apparatuses of the present invention are achieved without incurring any substantial relative disadvantage.

### SUMMARY OF THE INVENTION

The disadvantages and limitations of the background art discussed above are overcome by the present invention. With this invention, an automated adhesive segment applicator apparatus is provided having a carrier tape dispensing system that prevents the adhesive segment-laden carrier release tape from becoming loose or pulling away from the adhesive segment applicator apparatus when an adhesive segment is dispensed, in order to easily dispense an adhesive segment to a surface of a work piece. The automated adhesive segment applicator apparatus of the present invention provides a manner of applying adhesive segment-laden carrier release tape to non-flat, recessed, difficult to reach, or unstable surfaces.

The carrier release tape used in the present invention is flexible, extends longitudinally, and in the preferred embodiment can have a transverse width of approximately one inch. Additionally, it has opposed first and second release surfaces which have different release properties. Adhesive segments are arrayed generally longitudinally along the first release surface of the carrier release tape (although they instead may be staggered if desired). While the adhesive segments are preferably circular, they may instead be of other different shapes and configurations including, but not limited to, squares, triangles, ovals, dots, other geometric figures, caricature shapes, and the like.

The carrier release tape may be made from plain stock carrier release tape, which can be cut into individual tape strips either before or after the adhesive segment application processes. The transverse width of the preferred embodiment is approximately one inch although the dimensions of the carrier release tape strips may vary in accordance with the advancement mechanism associated with the adhesive segment applicator apparatus of the present invention with which it is used.

The second surface of the carrier release tape has a release property different from that of the first so that adhesive segments do not adhere to the second surface as strongly as they do to the first surface. When the carrier release tape is wound into rolls, the first surface, and thus, the adhesive segments applied thereto, will be the external surface of the roll of adhesive segment-laden carrier release tape.

In certain preferred embodiments of the present invention, the carrier release tape includes an indexing instrumentality such as a registration line printed on to either surface of the carrier release tape. The indexing instrumentality is preferably capable of optical detection by an optical sensor located within the adhesive segment applicator apparatus for readily advancing and precisely positioning the adhesive segment-laden carrier release tape, exposing the next adhesive segment on the carrier release tape. Alternatively, the indexing instrumentality may consist of a plurality of patterned scores, cuts, or indentations located in the surface of the carrier release tape, capable of optical detection or otherwise allowing for an advancement mechanism to protrude therethrough. Adhesive segments may be pre-metered onto the carrier release tape before indexing occurs, or the indexing may occur first and the adhesive may be applied thereafter.

A first embodiment of an automated adhesive segment applicator apparatus of the present invention contains a carrier tape dispensing system, an automated adhesive advancing mechanism, a carrier tape detection system, and a housing. The carrier tape dispensing system includes a supply spool that is rotatably mounted inside the housing of the adhesive segment applicator apparatus. A roll of adhesive segment-laden carrier release tape is inserted onto the supply spool and engages the supply spool in a secure fashion, permitting the roll of adhesive segment-laden carrier release tape to rotate when the supply spool rotates.

The carrier tape dispensing system also includes a take-up spool that is rotatably mounted on a drive shaft inside the housing of the adhesive segment applicator apparatus. The take-up spool is driven by the automated adhesive advancing mechanism, causing the take-up spool to rotate.

The carrier tape dispensing system includes a series of roller elements rotatably mounted within the housing for guiding the carrier tape through the automated adhesive applicator.

The carrier tape dispensing system further includes an adhesive dispensing head which is mounted, preferably, substantially external to the housing of the adhesive segment applicator apparatus. The adhesive dispensing head is the point of application for the adhesive segments as they are dispensed on to a surface. The adhesive dispensing head may be in the form of a plate, a rotatably mounted wheel, or any other structure suitable for use in dispensing adhesive segments. Preferably, the external surface of the adhesive dispensing head contains a soft overmolded cushion or resilient cushion to permit the adhesive segment applicator apparatus to engage non-flat, recessed, difficult to reach, or unstable surfaces.

The carrier tape detection system includes at least one detector used in conjunction with the advancement mechanism. In particular, a work piece sensor is included substantially adjacent to the adhesive dispensing head for detecting when application of adhesive to a work piece has occurred. An optical index sensor is provided to detect the indexing instrumentality provided on the adhesive segment-laden carrier release tape for precisely advancing the carrier release tape to expose the next adhesive segment.

To prepare the automated adhesive segment applicator for operation, the roll of adhesive segment-laden carrier release tape is inserted onto the supply spool. The roll of adhesive segment-laden carrier release tape is wound with the adhesive segments facing outwardly. The second surface of the carrier release tape has a coefficient of friction different from that of the first surface so that the adhesive segments do not adhere to the second surface as strongly as they do to the first surface.

The carrier dispensing system provides a carrier tape path through the applicator whereby the adhesive segment-laden carrier release tape threaded over the applicator head such that the adhesive segments face outwardly and are exposed to the intended application surface/work piece during operation. After application of the adhesive, the spent carrier release tape advances from the applicator head back to the roll of adhesive segment-laden carrier release tape whereby the second surface (the surface with the lower coefficient of friction) of the spent carrier release tape contacts at least one of the adhesive segments on the wound roll of adhesive segment-laden carrier release tape.

By nature of the externally exposed adhesive segments on the roll of adhesive segment-laden carrier release tape, the second surface of the spent carrier release tape adheres to the adhesive segments on the wound roll of adhesive segment-laden carrier release tape and is held in place. However, because the second surface of the spent carrier release tape has a coefficient of friction different from that of the first surface, the adhesive segments do not adhere to it as strongly as they do to the first surface, and the spent carrier release tape can be advanced across the wound roll of adhesive segment-laden carrier release tape without pulling off adhesive segments from the roll.

The spent carrier release tape extends from the supply spool to the take-up spool. A free end of the spent carrier release tape is removably attached to the take-up spool and wound in a neat roll thereupon during operation of the applicator. At some point along the path of the carrier tape, the optical index marking sensor is positioned to detect the index markings on the carrier tape.

To operate the automated adhesive segment applicator of the present invention, the adhesive segment-laden carrier release tape is installed as described above. An adhesive segment is properly positioned onto the applicator head by interrupting the work piece detector and/or by placing a work piece in the appropriate position relative to the applicator head. This action sends a signal to the advancement mechanism to advance the carrier release tape.

By virtue of the carrier tape dispensing system, and the carrier tape path provided therewith, the take-up spool drives the supply spool, causing it to rotate. The adhesive segment-laden carrier release tape on the supply spool is then advanced to properly position the next proceeding adhesive segment on to applicator head, as determined by the optical index marking detector. The advancement mechanism ceases advancement of the adhesive segment-laden carrier release tape each time an index marking is detected by the optical index marking detector.

It may therefore be seen that the present invention provides an automated system for advancing the adhesive segment-laden carrier release tape after each application of an adhesive segment to a work piece. Preferably, a single adhesive segment is positioned on to the applicator head each time the adhesive segment-laden carrier release tape is advanced. However, depending on the desired end use application of applicator of the present invention, the adhesive segment-laden carrier release tape and index markings thereon, and the advancement mechanism can be configured to advance the tape such that more than one adhesive segment is positioned on the applicator head.

The carrier tape dispensing system provided in the automated adhesive segment applicator of the present invention, by virtue of the configuration of roller elements and orientation of the supply spool and the take-up spool, imparts the applicator with a the carrier tape path that ensures the spent carrier release tape is held in place by contacting at least one adhesive segment on the roll of adhesive segment-laden carrier release tape. This configuration ensures proper tension in the carrier tape throughout the applicator, allowing for efficient and easy application of adhesive without the carrier tape being pulled away from the applicator head during continuous and/or high volume operation of the applicator.

In certain other embodiments of the present invention, the applicator may be provided without the carrier tape detection system, whereby the adhesive segment-laden carrier release tape is advanced through the applicator in a continuous manner with the rate of carrier tape advancement being selected by the operator or preset by design. Importantly, in these embodiments, the applicator includes the carrier tape dispensing system and a carrier tape path as described above with reference to the first embodiment, such that the carrier tape is prevented from pulling away from the applicator head during application of an adhesive segment to a work piece.

It may therefore be seen that the present invention teaches an automated adhesive segment applicator apparatus including an adhesive segment-laden carrier release tape that is always in a secure position, and is not permitted to come loose or pull away from the adhesive segment applicator apparatus. Indeed, the adhesive segment applicator apparatus of the present invention maintains proper tension on the adhesive segment-laden carrier release tape so that the adhesive segments are easily and efficiently removed from the carrier release tape.

It may also be seen that the automated adhesive segment applicator apparatus contains an automated adhesive dispensing system including a carrier tape detection system for use with carrier release tape having an indexing instrumentality that permits automatic advancement of the adhesive segment-laden carrier release tape during application of an adhesive segment to a surface. In addition, it may be seen that the present invention provides a adhesive segment applicator apparatus that automatically winds the spent carrier release tape onto a roll—thereby reducing the problem of scrap carrier tape interfering with the adhesive application process.

Each implementation of the automated adhesive segment applicator apparatus of the present invention is of a construction which is both durable and long lasting, and they will require little or no maintenance to be provided by the user throughout its operating lifetime. The automated adhesive segment applicators of the present invention are also of inexpensive construction to enhance their market appeal and to thereby afford them the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is an isometric view of a roll of indexed adhesive segment-laden carrier release tape for use in the adhesive segment applicator apparatus of the present invention;

FIG. 2 is a top plan view of a segment of the indexed adhesive segment-laden carrier release tape illustrated in FIG. 1;

FIG. 3 is a partial, top plan view of a segment of a first alternative indexed adhesive segment-laden carrier release tape showing an alternative indexing instrumentality;

FIG. 4 is a partial, top plan view of a segment of a second alternative indexed adhesive segment-laden carrier release tape showing an alternative perforated indexing instrumentality;

FIG. 5 is a partial, top plan view of a segment of a third alternative indexed adhesive segment-laden carrier release tape showing an alternative notched indexing instrumentality;

FIG. 6 is a side view of a adhesive segment applicator apparatus of the present invention (illustrating a plate-type adhesive applicator head);

FIG. 7 is a front view of the adhesive segment applicator apparatus illustrated in FIG. 6;

FIG. 8 is a top plan view of the adhesive segment applicator apparatus illustrated in FIGS. 6 and 7;

FIG. 9 is a rear view of the adhesive segment applicator apparatus illustrated in FIGS. 6 through 8;

FIG. 10 is a partial front view of the adhesive segment applicator apparatus illustrated in FIGS. 6 through 9 (shown without the enclosure portion of the housing);

FIG. 11 is a side view of the adhesive segment applicator apparatus illustrated in FIGS. 6 through 10, showing the tape retaining plates installed thereon; and

FIG. 12 is a side view of a second alternate embodiment of the adhesive segment applicator apparatus of the present invention (illustrating a roller-type adhesive applicator head).

### DETAILED DESCRIPTION OF THE PREFERRED EMBODIMENT

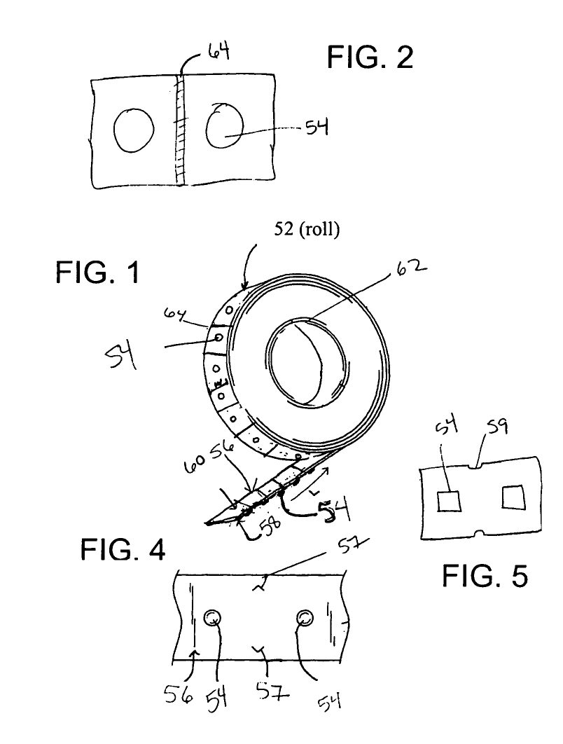

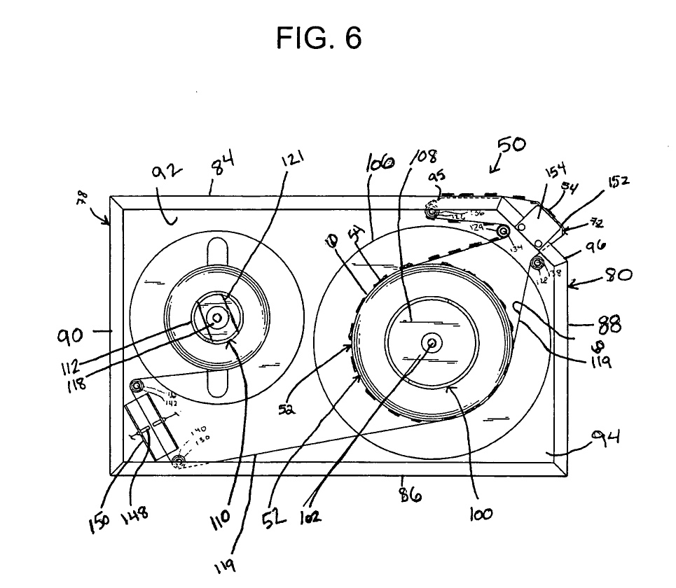

The preferred embodiment of the automated adhesive segment applicator apparatus of the present invention is illustrated generally in FIGS. 6 through 13, with the indexed adhesive segment-laden carrier release tape used therein being illustrated in FIGS. 1 through 5. Specifically, the preferred embodiment of the present invention is focused upon an automated adhesive segment applicator 50 and the manufacture and construction thereof, illustrated generally in FIG. 6, and a roll of adhesive segment-laden carrier release tape 52, including a plurality of adhesive segments 54, used therein. The detailed description of the preferred embodiment of the present invention also discloses a system and method for automatically applying adhesive segments 54 from the adhesive segment-laden carrier release tape 52 using the automated adhesive segment applicator 50 described herein.

Referring first to FIGS. 1 through 5, the roll of adhesive segment-laden carrier release tape 52 for use in the automated adhesive segment applicator 50 is illustrated. The roll of adhesive segment-laden carrier release tape 52 includes a differential carrier release tape 56, having a first surface 58 and a second surface 60 opposite the first surface 58. The carrier release tape 56 may be made of paper that has a silicone release material on the first 26 and second 28 surfaces.

Consistent with the broader aspects of the present invention, the carrier release tape 56 may be constructed of any flexible, transparent or semi-transparent or tinted transparent material. Such carrier materials can include, but are not limited to, polyester, polyethylene, polyvinyl chloride (PVC), vinyl, polystyrene, polyimide, polypropylene, polyolefin and/or paper-based materials.

The first surface 58 of the carrier release tape 56 has a coefficient of friction higher than the coefficient of friction of the second surface 60 of the carrier release tape 56, so that the first surface 58 of the carrier release tape 56 provides less release than does the second surface 60 of the carrier release tape 56. In particular, the silicone release material on the second surface 60 may be thicker than the silicone release material on the first surface 58.

Alternately, the silicone release material on the second surface 60 may contain a heavier coverage of silicone release material than the silicone release material on the first surface 58. In addition, any non-silicone release material, including water-based release coatings, solvent-based release coatings and/or wax-based release coatings, all well known to those skilled in the art, may be used in the present invention as long as the first surface 58 is provided with less release than the second surface 60.

The adhesive segments 54 may be any thermoplastic adhesive known to those skilled in the art, such as hot melt thermoplastic adhesives such as acrylics, natural and synthetic rubber-based adhesives, and amorphous polyolefin adhesives, pressure-sensitive silicones. Alternatively, pressure sensitive water-based adhesives can be used instead. The adhesives or glues contemplated by the present invention include those demonstrating good adherence to a wide number of materials, such as fabric, paper, wood, resin, plastics, metals, ceramic, foil, glass, expanded synthetic foam, and/or cement. The adhesive may be permanent or semi-permanent, and have any of a wide range of tack (degree of adhesiveness), depending on the specific project application.

The roll of adhesive segment-laden carrier release tape 52 can be manufactured by any method known to those skilled in the art and as disclosed in U.S. Pat. No. 5,935,670, U.S. Pat. No. 6,319,442, and U.S. patent application Ser. Nos. 10/920,151 and 10/920,154, each of which are hereby incorporated by reference in their entirety.

Accordingly, the adhesive segments 54 are preferably dispensed by a thermoplastic glue metering nozzle and supplied by a metering pump. As the first surface 58 of the carrier release tape 56 moves underneath thermoplastic glue metering nozzle, the adhesive segments 54 are dispensed onto the carrier release tape 56. An air jet may be directed onto the first surface 58 to cool the adhesive segments 54 as the carrier release tape 56 moves along.

Preferably, after application of the adhesive, the carrier release tape 56 includes a single row of the adhesive segments 54, and then is wound onto a take-up core 62 into rolls 52 with the adhesive segments 54, and thus, the first surface 58 of the carrier tape 56 facing outwardly, as illustrated in FIG. 1. The core may optionally be provided with projections which cooperate with a supply spool of the automated adhesive segment applicator 50 to ensure that the roll of adhesive segment-laden carrier release tape 52 is placed into the adhesive applicator 50 in the correct orientation.

The differential release properties of the silicone release material on the first surface 58 and the second surface 60, the fact that the adhesive segments 54 were initially applied in a hot state to the first surface 58 causing better adherence, and the fact that there is some cooling and hence “skinning over” of the adhesive segments 54 prior to the winding the take-up core 62 all ensure that the adhesive segments 54 remain adhered to the first surface 58 as the roll 52 is subsequently unwound.

It should be noted that although the adhesive segments 54 described and illustrated herein are generally circular in shape, the present invention may be applied to and employ adhesive segments on the carrier release tape which have any other generally two dimensional shape (e.g. squares, rectangles, lines, stars, triangles, etc.). In addition, the adhesive segments 54 may also come in various thicknesses, such as, for example, low (approximately one-sixty-fourth of an inch thick), medium (approximately one-sixteenth of an inch thick), and high (approximately one-eighth of an inch thick). The shape and thickness of the adhesive segments may determined in general by the shape or other characteristics of the thermoplastic glue metering nozzles 30 used to apply the thermoplastic adhesive to the carrier release tape 56.

Consistent with the broader aspects of the present invention, the adhesive segments 54 may be disposed on the carrier release tape 56 in a wide variety of colors (including transparent adhesives) and scents. For example, in making an adhesive segment for use with gift cards secured to a letter or other paper sheet for a coffee franchise, adhesive segments which smell like coffee could be used.

Further, while the adhesive segment-laden carrier release tape 52 is illustrated with the adhesive segments 54 aligned along its longitudinal dimension “L”, it will be appreciated by those skilled in the art that the adhesive segments 54 may be staggered along its longitudinal direction in any position across its width dimension “W” (e.g. in a zigzag orientation), depending on a particular end-use application.

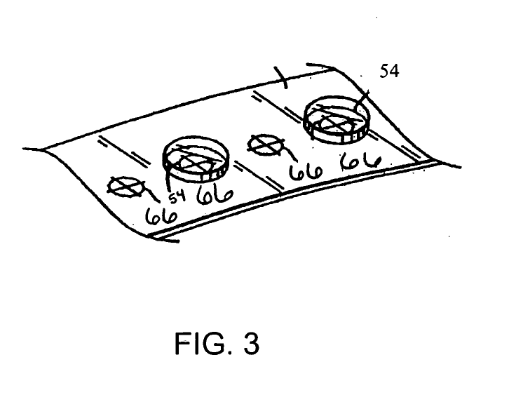

In accordance with the present invention, the adhesive segment-laden carrier release tape 52 has a series of optically detectable index markings formed thereon. As will be described in more detail below, these optically detectable index markings are employed by the automated adhesive segment applicator 50 in accordance with the present invention to accurately position adhesive segments for application by the applicator. As illustrated, for example, in FIGS. 1 and 2, the optically detectable index markings may take the form of lines 64 formed on the carrier release tape 56 and extending transversely across the width “W” of the carrier release tape 56 between the adhesive segments 54 thereon. It should be understood that various different types of optically detectable index markings on the adhesive segment-laden carrier release tape 56 may be employed. For example, as illustrated in FIG. 3, printer registration marks 68 may be placed in regular positions along the carrier release tape 56.

Whatever index markings 64, 68 are employed, the index markings 64, 68 may be formed on either or both surfaces 58, 60 of the carrier release tape 56. Besides being formed on one or both surfaces 58, 60 of the carrier release tape 56, the index markings may also be formed as perforations 57, notches 59 or other cuts or holes formed into the carrier release tape 56 that may be detected by an optical detector, as illustrated in FIGS. 4 and 5. As such, consistent with the broader aspects of the present invention, the applicator 50 may utilize a mechanical detection system in conjunction with a carrier tape provided with perforations 57 or notches 59, as will be well known to those skilled in the art.

Referring again to FIG. 3, the optically detectable index markings 66 may be positioned on the surfaces 58, 60 of the carrier release tape 56 not only between the adhesive segments 54 thereon, but also at different positions on the surfaces 58, 60 of the tape 56 with respect to the adhesive segments 54. For example, the adhesive segments 54 on the carrier release tape 56 may be made of a transparent thermoplastic material, in which case the index markings 64 or 66 may be positioned partially or entirely beneath the adhesive segments 54 on the carrier release tape 56 and still be detectable by an optical detector.

Preferably, the index markings 64, 66 may be pre-printed or otherwise formed on or in the carrier tape 56 before the adhesive segments 54 are deposited thereon. Alternatively, the index markings 64, 66 may be printed or otherwise formed on or in the carrier tape 56 after depositing the adhesive segments 54 on the carrier tape 56. The index markings 64, 66 may be applied using any means known to those skilled in the art. In particular, a printer, such as a laser printer or similar device, may be used to place the index markings 64 and 66 on one or both surfaces of the carrier release tape 56 before the adhesive segments 54 are deposited thereon.

Note that if the index markings to be used are physical indentations, notches, punctures, or perforations in or through the carrier tape 56, a device other than the printer, such as a rotary die with a plurality of die blades attached around its outer circumference, may be used to form the index markings in the carrier release tape 56. In any case, whether printed or formed on the carrier release tape 56 by the manufacturer thereof or during the process of applying adhesive segments 54 to the carrier release tape 56, the optically detectable index markings are preferably formed on the carrier release tape 56 in a uniformly spaced apart longitudinal progression along the length “L” of the carrier release tape 56.

Preferably, during application of the adhesive segments 54 to the carrier release tape 56 it is important that the adhesive segments 54 be deposited on the carrier release tape 56 along the length “L” of the carrier release tape 56 in a consistent relative position to the index markings formed on the carrier release tape 56.

It should be noted that, in some cases, the adhesive segments 54 deposited on the carrier tape 56 may be detectable, or made detectable, by an optical detector. Therefore, the adhesive segments 54 may themselves be used as index markings. For example, thermoplastic adhesives used to form the adhesive segments 54 may be formulated for varying properties such as degrees of tack, etc. The thermoplastic adhesives 54 may also be formulated for optical detectability, e.g., by compounding the thermoplastic adhesive with colors or other optically detectable characteristics. For example, luminescence under ultra-violet is a natural characteristic of some thermoplastic adhesives and this fact may be used to employ adhesive segments 54 formed of such thermoplastic adhesives as index markings themselves.

Throughout the remainder of this patent application the index markings printed, or otherwise formed in or on the carrier release tape 56 will be referred to with reference to the exemplary line index markings 64 described and illustrated with reference to FIG. 1.

However, it should be understood, that the term “index markings” and “optically detectable indices” and any similar terms as used throughout this application, including in the claims, also refers to other type of index markings, whether printed on or formed in the carrier release tape 56 including optically detectable adhesive segments 54 deposited on the carrier release tape 56.

Referring next to FIGS. 6 through 13, the automated adhesive segment applicator 50 contains a carrier tape dispensing system, illustrated generally at 70, an adhesive applicator head 72, a work piece detector 74, an advancement mechanism, indicated generally at 76, and an applicator housing, indicated generally at 78.

The applicator housing 78 is preferably formed in two portions, a main body portion 80, which houses the carrier tape dispensing system 70, and a smaller enclosure portion 82, which retains the advancement mechanism 76. The main body portion 80 and the enclosure portion 82 of the housing 78 are preferably constructed of stainless steel. However, the main body portion 80 and/or the enclosure portion 82 may be constructed of any relatively rigid or sturdy material, such as plastic, to provide a durable automated adhesive segment application 50 according to the present invention.

The main body portion 80 of the applicator housing 78 includes a top 84, a bottom 86, a front 88, a back 90, a closed side 92, which abuts the enclosure portion 82, and an open side 94. The top 84 of the main body portion 80 includes a tape guide opening 95 from which the adhesive segment-laden carrier release tape 52 exits the interior of the applicator housing 78. The tape guide opening 95 may be positioned along the top 84 of the main body portion 80 at any location, depending on the particular end use application, as will be described in more detail below. The main body portion 80 further includes a corner 96 utilized for attachment of the applicator head 72 and an opening 98 through which spent carrier tape will travel after removal of an adhesive segment, as will be discussed in more detail below.

The carrier tape dispensing system 70 includes a supply spool 100 rotatably mounted on a shaft 102 secured to the side 92 of the main body portion 80 of the applicator housing 78. The supply spool 100 may alternatively be rotatably mounted inside the housing 78 of the adhesive segment applicator apparatus 50 by any means known to those skilled in the art. In certain embodiments, the supply spool 100 may be removably, rotatably mounted within the main body portion 80 so that supply spools of different sizes and configurations can be interchanged with the supply spool 100.

The supply spool 100 includes a spacer element 104, a separating plate portion 106 and a tape roll supporting core 108. The tape roll supporting core 108 is configured to securely support the roll of adhesive segment-laden carrier release tape 52, as illustrated in FIG. 6. The roll of adhesive segment-laden carrier release tape 52 engages the tape roll supporting core 108 of the supply spool 100, permitting the roll of adhesive segment-laden carrier release tape 52 to rotate when the supply spool 100 rotates.

The tape roll supporting core 108 and the spacer element 104 are preferably formed of a rigid thermoplastic; however, the tape roll supporting core 108 and/or the spacer element 104 may be formed of any substantially rigid material known to those skilled in the art including, for example, a metal or a composite material. The separating plate portion 106 is preferably formed of stainless steel. Alternatively, the separating plate 108 can be formed of any metal or other relatively rigid material such as plastic. In certain embodiments of the present invention the complete supply spool 100, or any portion thereof, including but not limited to the spacer element 104, the separating plate portion 106 and the tape roll supporting core 108, may be integrally formed and rotatably mounted inside the main body portion 80 of the applicator housing 78.

The carrier tape dispensing system 70 also includes a take-up spool 110, which is preferably, smaller than the supply spool 100. The take-up spool 110 comprises a spacer element 112, a separating plate portion 114 and a spent tape accumulating core 116. The take-up spool 110 is mounted on a drive shaft 118 for rotatably driving the take-up spool 110 during operation of the automated adhesive dispensing applicator 50. In certain embodiments, the take-up spool 110 may be removably mounted to the drive shaft 118 within the main body portion 80 so that take-up spools 110 of different sizes can be interchanged with the take-up spool 110.

Spent carrier release tape 119, with the adhesive segments removed therefrom, is wound around the accumulating core 116 of the take-up spool 110. Slots 121 or other structures may be formed in the accumulating core 116 in which the end of the spent carrier release tape 119 may be positioned to removably attach to the take-up spool 110. In certain alternate embodiments, the adhesive segment applicator 50 may be provided with a spent tape take-up core configured to fit on to the accumulating core 116 of the take-up spool 110 for winding the spent carrier release tape 119 thereupon.

The accumulating core 116 and the spacer element 112 are preferably formed of a rigid thermoplastic; however, the accumulating core 116 and/or the spacer element 112 may be formed of any substantially rigid material known to those skilled in the art including, for example, a metal or a composite material. The separating plate portion 114 is preferably formed of stainless steel. The separating plate portion 114 can be provided with apertures 113 so that the spent carrier release tape 119 may be easily removed from the accumulating core 116. The separating plate portion 114 may also be formed of any metal or other relatively rigid material such as plastic. In certain embodiments of the present invention the complete take-up spool 110, or any portion, including but not limited to the spacer element 112, the separating plate portion 114 and the accumulating core 116, may be integrally formed and mounted to the drive shaft 118 inside the main body portion 80 of the applicator housing 78.

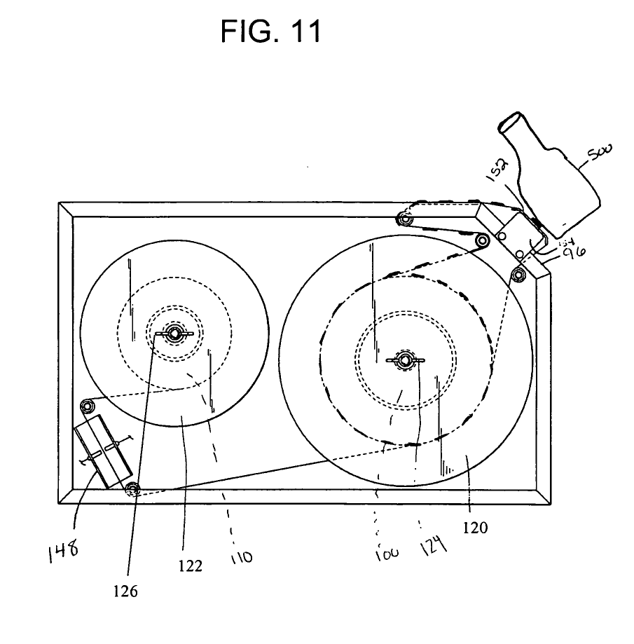

As best illustrated in FIG. 11, the supply spool 100 and the take-up spool each include a tape retainer 120 and 122, respectively. The tape retainer 120 is removably mounted to the core 108 of the supply spool 100 after a roll of adhesive segment-laden release tape 52 has been installed thereupon. When in position on the supply spool 100, the tape retainer 120 maintains and guides the carrier tape 56 coming off of the roll of adhesive segment-laden release tape 52, which exits the housing, and maintains and guides the spent carrier release tape 119 as it travels back into the housing to the take-up spool 110. The tape retainer 120 is removably mounted to the core 108 of the supply spool 100 using a wing nut 124 or any other securing device known to those skilled in the art.

The tape retainer 122 is removably mounted to the core 112 of the take-up spool 110. When in position on the take-up spool 110, the tape retainer 122 maintains and guides the spent carrier release tape 119 being wound on the take-up spool 110 into a neat roll. The tape retainer 122 is removably mounted to the core 112 of the take-up spool 110 using a wing nut 126 or any other securing device known to those skilled in the art.

The tape retainers 120 and 122 are preferably constructed of stainless steel. Alternatively, the tape retainers 120 and 122 may be constructed of another metal material or another relatively rigid material, such as a plastic or a composite material.

The carrier tape dispensing system 70 further includes rollers 124, 126, 128, 130 and 132 rotatably mounted onto roller shafts 134, 136, 138, 140 and 142, respectively, provided in the main body portion 80 of the applicator housing 78. As illustrated in FIGS. 6 through 13, two rollers 124 and 126 are provided to guide the carrier tape 56 coming off of the roll of adhesive segment-laden release tape 52 as it exits the main body portion 80 of the applicator housing 78. Roller 128 guides the spent carrier release tape 119 as it reenters the main body portion 80 of the applicator housing 78 after application of an adhesive segment 54 to a work piece. Rollers 130 and 132, positioned near the back 90 of the main body portion 80, further guide the spent carrier release tape 119 as it is wound on to the take-up spool 110.

Importantly, placement of the rollers 124, 126, 128, 130 and 132 within the main body portion 80 of the applicator housing 78 provide for proper orientation of the carrier tape and thus, proper tension in the carrier tape between the supply spool 100, the adhesive applicator head 72 and the take-up spool 110 during operation of the automated adhesive applicator 50, as will be described in more detail below.

The rollers 124, 126, 128, 130 and 132, in conjunction with the supply spool 100 and take-up spool 110, are positioned to provide a novel carrier tape path of the present invention, as illustrated in FIG. 6. In particular, the second surface 60 of the spent carrier release tape 119 entering the main body portion 80 of the housing 78 contacts an arcuate portion of the roll of adhesive segment-laden release tape 52 on the supply spool 100. The spent carrier tape 119 is therefore temporarily held in place by the adhesive segments 54 on the first surface 58 of the roll of adhesive segment-laden release tape 52 so that the carrier tape can not be pulled away from the applicator head 72 during adhesive dispensation, as best illustrated in FIG. 6.

The spent carrier tape may contact any portion of the roll of adhesive segment-laden release tape 52 on the supply spool 100 including arcuate portions of about 1 to about 225 degrees of the perimeter of the roll of adhesive segment-laden release tape 52. More preferably, the spent carrier tape may contact an about 1 to about 180 degree arcuate portion of the roll of adhesive segment-laden release tape 52, and even more preferably the spent carrier tape may contact an about 1 to about 100 degree arcuate portion of the roll of adhesive segment-laden release tape 52.

Consistent with the broader aspects of the present invention, placement of rollers 124, 126, 128, 130 and 132 may be in any location that provides the proper orientation and tension in the carrier tape (i.e. the proper carrier tape path). Accordingly, there may be provided more or less rollers in the applicator 50 of the present invention as long as the rollers permit the second surface 60 of the spent carrier tape 119 to contact at least one adhesive segment 54 on the roll of adhesive segment-laden release tape 52 in order to prevent the carrier release tape 56 from pulling away from the applicator head 72 when the adhesive is being dispensed. As such, depending on the size and configuration of the roll of adhesive segment-laden release tape 52, and depending on the size and configuration of the supply spool 100 and the take-up spool 110, one or more of rollers 124, 126, 128, 130 and 132 may not be utilized for in a given adhesive application project.

Rollers 124, 126, 128, 130 and 132 are preferably coated with a silicone material to permit the rollers 124, 126, 128, 130 and 132 to easily rotate with the carrier tape 56 as it moves through the adhesive applicator 50 while also ensuring that the adhesive segments 54 do not adhere to the rollers and also ensuring that the carrier tape does not slip or pull away from the rollers during operation. As such, the rollers 124, 126, 128, 130 and 132 may be covered with any such material known to those skilled in the art.

The carrier tape dispensing system 70 also includes an optical index marking detector 148 mounted to the side 92 of the main body portion 80 of the housing 78 with a bracket 150. The optical detector 148 is employed to detect the index markings 64 formed on the adhesive segment-laden carrier release tape 52. The optical detector 148 may be implemented in any conventional manner, and specifically, is selected and implemented to detect the particular type of index marking formed on or in the carrier release tape 56. The optical index marking detector 148 may be mounted in any appropriate and convenient place in the applicator housing 78 to detect the index markings 64.

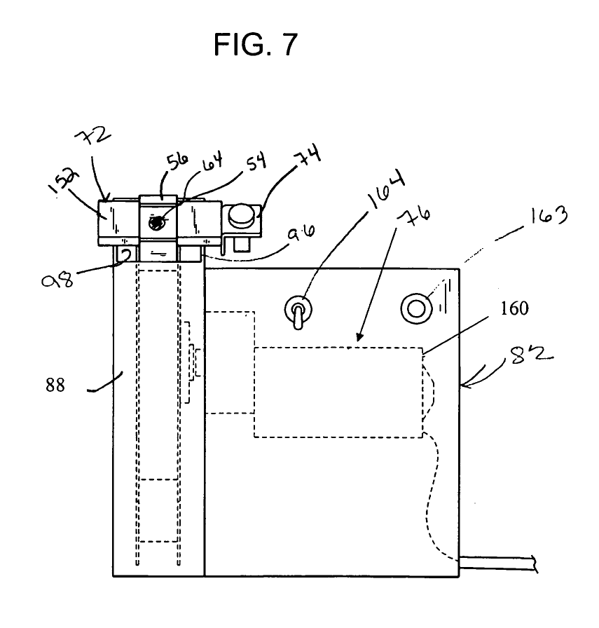

Turning for the moment to FIGS. 7 and 8, in addition to FIGS. 6 and 9-12, the applicator head 72 is positioned at the corner 96 of the main body portion 80. The applicator head 72 provides an area for presentment of one or more adhesive segments 54 for application of such adhesive segments to a work piece. As illustrated in FIGS. 6, 7 and 11, the applicator head 72 may be in the form of a plate element 152 providing a surface for dispensing an adhesive segment on to a work piece 500. The plate element 152 may be secured to the main body portion 80 of the applicator housing 78 by a bracket 154 or by any conventional means known to those skilled in the art. In addition, the plate element 152 can optionally be covered with a shock absorbing material, such as a foam or rubberized material, for assisting in application of adhesives to non-planar or fragile work pieces.

As best illustrated in FIG. 12, the applicator head 72 may be in the form of a dispensing roller 156 rotatably secured to the corner 96 of the main body portion 80. The roller 156 may be rotatably mounted to the housing 78 by any conventional means known to those skilled in the art. The roller 156 preferably contains a soft overmolded cushion or resilient cushion around its external circumference permitting the adhesive segment applicator apparatus 50 to engage non-flat, recessed, difficult to reach, or unstable surfaces.

Accordingly, the size and shape of the applicator head 72 (e.g. the plate element 152 or the roller 156) preferably corresponds to the size and shape of the work piece 500 and/or the adhesive segments 54 that are to be applied to the work piece. As such, the applicator head 72 may be of any size or shape required by a given end-use application. For example, the applicator head 72 may be configured to present more than one adhesive segment 54 to a work piece, allowing for multiple adhesive segments 54 to be dispensed at a given time. Further, it will at once be appreciated by those skilled in the art that the applicator head 72 may be configured or positioned in any convenient location or orientation on the main body portion 80 of the housing 78, depending on the type of work piece and/or end use of the applicator 50. Accordingly, the present invention can include a movable/positionable applicator head 72 that can be conveniently configured in different locations and positions by an operator from job to job.

Regardless of the type of applicator head 72 that is utilized in the applicator 50, the work piece detector 74 is mounted on to the housing 78 in a position adjacent to the applicator head 72 to optically detect the placement or application of a work piece onto the applicator head 72. The work piece detector 74 may be implemented in any conventional manner, and specifically, is selected and implemented to detect a work piece of any size or shape. The work piece detector 74 may be mounted in any appropriate and convenient place on the applicator housing 78 to detect a work piece.

Turning now to FIGS. 7 through 9, the advancement mechanism 76 is provided to move the carrier strip through the applicator 50. The advancement mechanism 76 includes a take-up spool motor 160, including but not limited to any stepper, servo motor and/or magnet motor known to those skilled in the art, for driving the take-up spool 110. Preferably, the motor 160 is a variable speed motor. The take-up spool motor 160 may be mounted within the enclosure portion 82 of the housing 78 on the side of the take-up spool 110 adjacent to the separating plate 114. Alternatively, the enclosure portion 82 and the motor 160 housed therein can be mounted in any convenient location on the applicator 50 including at the rear 90 or at the side 94 of the main body portion 80.

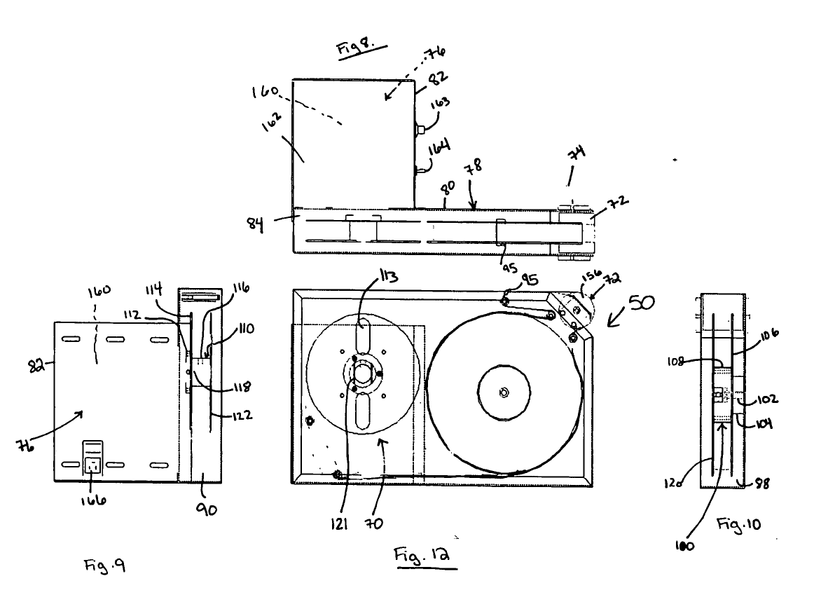

As illustrated in FIGS. 8 and 9, the drive shaft 118 may extend from the motor 160 through the spacer element 112, the separating plate 114 to engage the accumulating core 116 in order to rotate the take-up spool when advancing the adhesive segment-laden release tape 52. Consistent with the broader aspects of the present invention and as will be well known to those skilled in the art, the motor 160 may instead be used to drive the supply spool 100 with the take-up spool 110 being instead driven by rotation of the supply spool 100.

The advancement mechanism 76 further includes an advancement controller 162, used in conjunction with the work piece detector 74 and the optical index marking detector 148, implemented in a conventional manner for advancing the carrier tape as described herein. The advancement mechanism 72 further includes a speed controller 163 for controlling the speed of carrier tape advancement. For example, each of the controllers 162 and 163 may be implemented in whole or in part using a microprocessor or other programmable device and/or using in a combination of discreet digital and/or analog circuitry. Further, it will be appreciated that a single controller may be used to control precise advancement of the carrier tape as well as advancement speed of the carrier tape.

The advancement mechanism 72 additionally includes a toggle switch 164 for turning on and off the detectors 74 and 148 and to provide for continuous operation of the automated adhesive applicator 50, as described in more detail below. The toggle switch 164 is preferably a three position switch with a <power off> position, a <detectors off> position and a <detectors on> position. The advancement mechanism 72 is receives power via the input 166 located on the enclosure portion 82 of the housing 78.

To prepare the automated adhesive segment applicator 50 of the present invention for operation, a roll of adhesive segment-laden carrier release tape 52 is inserted onto the supply spool 100. As illustrated in FIG. 1, the roll of adhesive segment-laden carrier release tape 52 is wound with the adhesive segments 54 facing outwardly, i.e. with the first surface 58 facing outwardly, and with a second surface 60 facing inwardly. The second surface 60 of the carrier release tape 56 has a coefficient of friction different from that of the first surface 58 so that adhesive segments 54 do not adhere to the second surface 60 as strongly as they do to the first surface 58.

In certain embodiments of the present invention, the path of the carrier tape through the apparatus 50 is as illustrated in FIG. 6. Accordingly, the adhesive segment-laden carrier release tape 52 is threaded under the roller 124 and around roller 126, through opening 95 and over the applicator head 72 such that the adhesive segments 54 face outwardly so that the adhesive segments 54 will be exposed to the intended application surface/work piece during operation. (It will be appreciated that since the opening 95 may be anywhere along the top 84 of the main body portion 80, more than one adhesive segment can be exposed outside the housing 78 at any given time.)

After application of the adhesive, spent carrier release tape 119 advances from the applicator head 72 to the roller 128 and back to the roll of adhesive segment-laden carrier release tape 52 whereby the second surface 60 (the surface with the lower coefficient of friction) of the spent carrier release tape 119 contacts at least one of the adhesive segments 54 on the wound roll of adhesive segment-laden carrier release tape 52. By nature of the externally exposed adhesive segments 54 on the roll of adhesive segment-laden carrier release tape 52, the second surface 60 of the spent carrier release tape 119 adheres to the adhesive segments 54 on the wound roll of adhesive segment-laden carrier release tape 52 and is held in place. However, because the second surface 60 of the spent carrier release tape 119 as a coefficient of friction different from that of the first surface 58 the adhesive segments 54 do not adhere to it as strongly as they do to the first surface 58, the spent carrier release tape 119 can be advanced across the wound roll of adhesive segment-laden carrier release tape 52 without pulling off adhesive segments 54 from the roll.

The spent carrier release tape 119 extends from the supply spool 100 to the rollers 130 and 132, which are configured such that the index markings 64 may be detected by the optical index marking detector 148. A free end of the spent carrier release tape 119 is removably attached to the take-up spool 110 using slots 121 in the accumulating core 116, and the spent carrier release tape 119 continues to wind in a neat roll thereupon during operation of the applicator 50.

To operate the automated adhesive segment applicator 50 of the present invention, the adhesive segment-laden carrier release tape 54 is installed as described above and an adhesive segment 54 is exposed on the applicator head 72 of the adhesive segment applicator 50. The power is supplied to the applicator via the power input 166. The toggle switch 164 is positioned in the <detectors on> position.

In the <detectors on> mode of the adhesive applicator 50, an adhesive segment 54 may be properly positioned onto the applicator head 72 by interrupting the work piece detector 74 and/or by placing a work piece in the appropriate position relative to the applicator head 72 relative to the work piece detector 74. This action sends a signal to the controller 162 to advance the carrier release tape 52.

The controller 162 causes the motor 160 to rotate the take-up spool 110 via the drive shaft 118, advancing the carrier release tape through the applicator 50. By virtue of the carrier tape dispensing system 72, and the carrier tape path provided therewith, the take-up spool 110 winds the spent carrier tape 119 thereupon which in turn drives the supply spool 100, causing it to rotate. The adhesive segment-laden carrier release tape 52 on the supply spool 100 is then advanced to properly position the next proceeding adhesive segment 54 on to applicator head 72, as determined by the optical index marking detector 148. Accordingly, the optical index marking detector 148 operates as a tape position sensor which provides an input to the controller 162 relative to the detected position of the index markings 64 on the carrier release tape 52. The controller 162 processes the signal received from the optical index marking detector 148 to determine, in a conventional manner, the position of the adhesive segment-laden carrier release tape 52. The controller 162 ceases advancement of the adhesive segment-laden carrier release tape 52 each time an index marking 64 is detected by the optical index marking detector 148.

It may therefore be seen that the <detectors on> mode of the present invention provides an automated system for advancing the adhesive segment-laden carrier release tape 52 after each application of an adhesive segment 54 to a work piece. Preferably, a single adhesive segment is positioned on to the applicator head 72 each time the adhesive segment-laden carrier release tape 52 is advanced. However, depending on the desired end use application of applicator 50 of the present invention, the adhesive segment-laden carrier release tape 52 and index markings 74 thereon, and the controller 162 can be configured to advance the tape 52 such that more than one adhesive segment is positioned on the applicator head 72.

Alternatively, rather than providing the work piece detector 74, this advancement process may be initiated manually, e.g., by a manual trigger that provides a trigger signal to the controller 162. The manual trigger may be implemented, for example, as a hand or foot operated switch that provides a trigger signal to the controller 162 to initiate advancement of the adhesive segment-laden carrier release tape 52 when an operator has positioned a work piece in a desired position or notes that a work piece is in the desired position for the application for an adhesive segment 32 thereto.

In the <detectors off> mode of the adhesive applicator 50, the speed controller 163 may be manually adjusted to continuously advance the adhesive segment-laden carrier release tape 52 at any rate desired by the operator. Accordingly, it will be appreciated by those skilled in that art that in the <detectors off> mode, a roll of adhesive segment-laden carrier release tape 52 without index markings may be used.

In either mode, the configuration of the carrier tape dispensing system 70, and therefore, the carrier tape path through the applicator 50, ensures that the adhesive segment-laden carrier release tape 52 is held in place during the application process. Accordingly, the carrier tape dispensing system 70, by virtue of the configuration of rollers 124, 126, 128, 130 and 132 and orientation of the supply spool 100 and the take-up spool 110, ensure that spent carrier release tape 119 is held in place by contacting at least one adhesive segment 54 on the roll of adhesive segment-laden carrier release tape 52. This configuration further ensures proper tension in the carrier tape throughout the applicator 50, allowing for efficient and easy application of adhesive without the carrier tape being pulled away from the applicator head 72 during continuous and/or high volume operation of the applicator 50.

Consistent with the broader aspects of the present invention, a particular use or application of adhesives may not require the use of each of the rollers 124, 126, 128, 130 and 132 or may necessitate the repositioning of one or more of the rollers 124, 126, 128, 130 and 132. Thus, the rollers 124, 126, 128, 130 and 132 (and additional rollers) may be provided in any configuration permitting the spent carrier release tape 119 to be held in place by least one adhesive segment 54 on the roll of adhesive segment-laden carrier release tape 52. Likewise, and consistent with the broader aspects of the present invention, the supply spool and the take-up spool may be in any configuration and/or orientation known to those skilled in the art within the housing that provide the carrier tape path, as herein described.

The applicator 50 may be oriented horizontally, as depicted in FIG. 6, vertically or in any other position, depending on the adhesive application work environment.

A second embodiment of the present invention can include an adhesive applicator 50 provided without one or both of the detectors 74 and 148. In this embodiment, the applicator 50 will be provided with the motor 160 and speed controller 163 for permitting automatic advancement of the carrier tape. As such, the toggle switch 164 will be essentially an on/of switch for the applicator 50. Importantly, in this embodiment, the applicator 50 will include the carrier tape dispensing system 70 and a carrier tape path as described above with reference to the first embodiment, such that the carrier tape is prevented from pulling away from the applicator head 72 during application of an adhesive segment to a work piece.

Further embodiments of the present invention can include one or more features of the first embodiment of the present invention as described above, with the specific applicator 50 configuration dictated by environmental, economic and usage requirements for adhesive application. However, the applicator include the carrier tape dispensing system 70 and a carrier tape path as described above with reference to the first embodiment, such that the carrier tape is prevented from pulling away from the applicator head 72 during application of an adhesive segment to a work piece.

It may therefore be seen that the present invention teaches an automated adhesive segment applicator apparatus including an adhesive segment-laden carrier release tape that is always in a secure position, and is not permitted to come loose or pull away from the adhesive segment applicator apparatus. Indeed, the adhesive segment applicator apparatus of the present invention maintains proper tension on the adhesive segment-laden carrier release tape so that the adhesive segments are easily and efficiently removed from the carrier release tape.

It may also be seen that the automated adhesive segment applicator apparatus of the present invention may include an advancement mechanism/carrier tape detection system for use with carrier release tape having an indexing instrumentality, thereby allowing for precise positioning of an adhesive segment relative to a work piece or work surface.

Although an exemplary embodiment of the automated adhesive segment applicator apparatus of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

1. An automated adhesive segment dispensing apparatus for dispensing a roll of adhesive-segment laden carrier tape and for winding spent carrier tape after application of adhesive therefrom, said apparatus comprising:
(a) a housing;
(b) a supply spool rotatably mounted to the housing and adapted to receive a roll of adhesive-segment laden carrier tape;
(c) a adhesive applicator head mounted to the housing;
(d) a motor-driven take-up spool rotatably mounted to the housing, adapted to receive an end of the spent carrier release tape, wherein rotation of the take-up spool drives rotation of the tape supply spool;
wherein the tape supply spool, take-up spool, and adhesive applicator head are mounted with respect to each other and the housing so as to provide a carrier tape path in which the spent carrier tape is in contact with an arcuate portion of the roll of adhesive-segment laden carrier tape on the supply spool.

2. The automated adhesive segment dispensing apparatus of claim 1, wherein the applicator head comprises one of a plate element and a roller element.

3. The automated adhesive segment dispensing apparatus of claim 1, wherein the tape supply spool, take-up spool, and adhesive applicator head are configured so as to ensure the spent carrier tape is in contact with at least one adhesive segment of the roll of adhesive-segment laden carrier tape.

4. The automated adhesive segment dispensing apparatus of claim 1, further comprising a variable speed motor mounted within the housing for rotating the motor-driven take-up spool and a speed controller mounted to the housing for varying the speed of rotation of the take-up spool thereby varying the speed of advancement of the adhesive-segment laden carrier tape.

5. The automated adhesive segment dispensing apparatus of claim 1, further comprising a carrier tape detection system mounted to the housing for advancing the adhesive-segment laden carrier tape.

6. The automated adhesive segment dispensing apparatus of claim 5, wherein the roll of adhesive-segment laden carrier tape includes a plurality of index instrumentalities disposed between each adhesive segment on the carrier tape and wherein the carrier tape detection system includes a detector for sensing index instrumentality.

7. The automated adhesive segment dispensing apparatus of claim 5, wherein the carrier tape detection system comprises a work piece detector mounted to the housing adjacent to the applicator head and a motor mounted within the housing, wherein the work piece detector is in communication with the motor for advancing the adhesive-segment laden carrier tape after application of an adhesive segment to a work piece.

8. An automated adhesive segment dispensing apparatus for dispensing adhesive segments from adhesive-segment laden carrier release tape and for winding spent carrier release tape with adhesive segments removed therefrom, said apparatus comprising:
(a) a housing;
(b) a carrier tape advancing system including a supply spool rotatably mounted to the housing and adapted to hold a roll of adhesive-segment laden carrier release tape, an applicator head mounted to the housing and a take-up spool rotatably mounted to the housing, adapted to receive an end of the spent carrier release tape, and coupled to the supply spool, wherein rotation of the take-up spool drives rotation of the supply spool to advance the adhesive-segment laden carrier release tape across the applicator head; and
(d) an advancement mechanism mounted to the housing for advancing the adhesive-segment laden carrier release tape; and
wherein the supply spool, take-up spool, and adhesive applicator head are mounted with respect to each other and the housing such that the adhesive-segment laden carrier release tape the roll of adhesive-segment laden carrier release tape on the supply spool may be extended from the supply spool, over the adhesive applicator head, and onto the take-up spool such that rotation of the take-up spool by the advancement mechanism winds spent carrier tape around the take-up spool.

9. The automated adhesive segment dispensing apparatus of claim 8, wherein the carrier tape dispensing system provides a carrier tape path in which a second surface of the spent carrier tape is in contact with at least one adhesive segment on the roll of adhesive-segment laden carrier release tape on the supply spool.

10. The automated adhesive segment dispensing apparatus of claim 8, wherein the advancement mechanism comprises a motor coupled to the take-up spool for rotating the take-up spool and winding spent carrier tape thereupon.

11. The automated adhesive segment dispensing apparatus of claim 10, wherein the motor is a variable speed motor and the advancement mechanism further comprises a speed controller for adjusting the speed of adhesive-segment laden carrier release tape advancement.

12. The automated adhesive segment dispensing apparatus of claim 8, wherein the advancement mechanism comprises a work piece detected mounted to the housing adjacent to the applicator head and a motor for advancing the adhesive-segment laden carrier release tape after application of an adhesive segment to a work piece.

13. The automated adhesive segment dispensing apparatus of claim 12, wherein the adhesive-segment laden carrier release tape includes a plurality of indexing instrumentalities uniformly spaced apart on the carrier release tape and wherein the advancement mechanism further comprises a detector mounted within the housing, wherein the motor ceases advancement the adhesive-segment laden carrier release tape when an indexing instrumentality is detected by the detector.

14. A method for automatically dispensing adhesive segments from a roll of adhesive-segment laden carrier release tape and winding spent carrier release tape thereon, said method comprising:
providing a carrier tape dispensing system mounted to a housing, wherein the carrier tape dispensing system includes a supply spool adapted to receive a roll of adhesive-segment laden carrier release tape, an applicator head and a take-up spool;
configuring the supply spool, the applicator head and the take-up spool in position with respect to each other, whereby the adhesive-segment laden carrier release tape from the roll of adhesive-segment laden carrier release tape advances from the supply spool over the applicator head and the spent carrier tape advances from the applicator head to the take-up core;
contacting the spent carrier tape coming from the applicator head with at least one adhesive segment on the roll of adhesive-segment laden carrier release tape on the supply spool wherein the adhesive-segment laden carrier release tape on the applicator head remains against the applicator head during application of an adhesive segment to a work piece.
